(19) United States
(12) Patent Application Publication
(10) Pub. No.: US 2005/0192920 A1
(43) Pub. Date: Sep. 1, 2005

(54) Real time data management apparatus, system and mehtod

(76) Inventors: Philip C. Hodge, Aurora, OH (US); Patrick Miranda, Valley City, OH (US)

Correspondence Address: ROETZEL AND ANDRESS, 222 SOUTH MAIN STREET, AKRON, OH, 44308, US

(21) Appl. No.: 10/780,271

(22) Filed: Feb. 17, 2004

(51) Int. Cl. G06F 7/00

(52) U.S. Cl. 707/1

(57) ABSTRACT

A data-management system and method to be provided to a digital computer terminal for generating a link in real time between an electronic document opened in a computer application and a target document. The digital computer terminal includes a computer readable memory and a data-capture device, and the data-management system includes data-capture logic for controlling capture of electronic data by the data-capture device, target-document logic for generating the target document from the electronic data, and link-generating logic for substantially simultaneously storing the target document in the computer readable memory and generating the link to the target document in the electronic document in real time.

### FIELD OF THE INVENTION

The present invention relates generally to data management, and more particularly to the real-time linking of hardcopy documents to a portion of a computer application.

### BACKGROUND OF THE INVENTION

Assertions made in legal, financial, and other formal printed publications, as well as other textual materials often require documentary evidence to support those assertions. Take, for example, a report detailing the findings of an internal audit conducted by a corporation to evaluate potential areas where costs can be reduced or eliminated. To establish what is currently being spent in these areas and offer insight into the magnitude of the potential savings, the report must accurately describe current costs and support this description with documentary evidence. The pieces of documentary evidence, also referred to as supporting documents, are typically attached at the end of the report as a series of exhibits, or are copied into the body of the report itself. Examples of such documentary evidence can include receipts that list the amount paid for raw materials, expenditures to update company equipment, memos between customers and employees, and so forth. Similarly, other supporting documents can be attached to establish debts incurred, accounts receivable, and so on. The same requirements for evidentiary support hold true in formal reports or documents to be submitted in a legal setting, such as in a court of law, and governmental reports, such as tax audits performed by the Internal Revenue Service, State Government Agencies, Independent Public Accounting Firms, specialized practice organizations and private accounting firms.

Searches for the supporting documents as part of an investigation, audit, or other process are typically conducted by professionals having an advanced knowledge of the subject matter being sought. Professionals conducting such searches will often expend a significant amount of time in remote document storage facilities locating and reproducing hardcopies of relevant documents. These facilities could represent decentralized branch offices, distribution centers, remote storage centers and the like. Conventional photocopiers are used to generate a copy of the original document, and the original document is then returned to its storage location. In cases where a photocopier is not available on site at the storage location, the professional searcher must tote the original documents to a photocopier, make copies, and then return the original documents to the storage facility. In transit to/from the storage facility and during the photocopying process, the original documents can be lost and/or damaged due to accidental mishandling of the documents and photocopier malfunctions. Although removing a large number of original documents from the storage facility at a time minimizes the number of trips to the photocopier required to generate copies of the original documents, it increases the risk that the documents will be accidentally returned to inappropriate storage locations. Further, costs associated with the time spent by professionals conducting such searches are high, and can make a single trip to an off-site photocopier cost prohibitive, and the paper photocopies generated by such a process leads to the production of waste.

More recently, the development of digital image capturing equipment allows original documents to be saved and reproduced electronically instead of as conventional photocopies. If the digital image capturing process takes place on site where the supporting documents are being stored, each document is briefly removed from its storage location, saved electronically with the aid of a scanner, and then returned to its storage location. Storing the electronic files in this way allows them to be retrieved and reviewed at a later date without actually producing a hardcopy of the documents. Reports including citations to the electronically stored files can then be transmitted electronically via email or a CD-ROM along with the electronic supporting documents. A person reading the report can open and review each of the supporting documents individually on a computer and produce a hardcopy of said supporting documents if desired.

An increasingly popular way of attaching supporting documents to a report or other document that is to be transmitted electronically as described above is to embed a link within the report that leads to the relevant supporting document. Such a practice, commonly referred to as hyperlinking, requires the searcher to sort through all of the supporting documents saved as electronic files and extract the particular supporting document(s) to be linked to the report. Once the storage location of the supporting document(s) is known, the searcher must then generate an icon in the report during a post electronic-file capture process to insert the link into the report.

Reports often include statements expressed frequently throughout the report that are supported by a single supporting document. The multiple locations in the report supported by the common supporting document can occur at regular intervals. Traditionally, links to the supporting documents in such circumstances have been generated at each location individually, despite the fact that the links will all lead to the same supporting document.

Accordingly, there is a need in the art for a document-management system and process for capturing and linking a supporting document to a location in an electronic document in real time. The document-management system and process should be user friendly, should minimize the time required for linking the supporting document to the electronic document, and should allow a plurality of supporting documents to be linked simultaneously in real time at one or more locations in the electronic document. Further, the document-management system and process should also provide for the linking of supporting documents presently stored in an electronic format.

### SUMMARY OF THE INVENTION

In accordance with one aspect, the present invention provides a data-management system to be provided to a digital computer terminal for generating a link in real time between an electronic document opened in a computer application and a target document. The digital computer terminal includes a computer readable memory and a data-capture device, while the data-management system includes data-capture logic for controlling capture of electronic data by the data-capture device, target-document logic for generating the target document from the electronic data, and link-generating logic for substantially simultaneously storing the target document in the computer readable memory and generating the link to the target document in the electronic document in real time.

In accordance with another aspect, the present invention also provides a computer application for linking a portion of an electronic document to a target document stored as electronic data representing an information object in a computer accessible memory. The computer application includes link-generating logic for generating a link to the target document in the electronic document; and data-management logic for transmitting the electronic document and the target document to a data storage device, wherein the data-management logic automatically updates a path of the link to render the link operable following the transmission.

In accordance with another aspect, the present invention also provides a data-management system for generating a plurality of links to target documents in an electronic document. The data-management system includes means for creating and editing the electronic document, means for generating a plurality of target documents from electronic data captured by a data-capture device, means for assigning a sequential identifier to each of the plurality of target documents as the target documents are generated, means for storing the plurality of captured target documents in a computer readable memory, and means for generating a link at a plurality of user-selected locations in the electronic document to the plurality of captured target documents.

In accordance with another aspect, the present invention also provides a system for linking a target document to a portion of an electronic document in real time. The system includes a computer application for generating and editing the electronic document; and link-generating logic operable with the computer application for generating a link to the target document, wherein the target document is an electronic reproduction of a hardcopy document and is to be generated by scanning the hardcopy document with an optical data-capture device, further wherein the link is to be generated at approximately the same time as the captured target document is to be saved, and further wherein the computer application is one of a group consisting of a spreadsheet, word processor, database, presentation application, and any combination thereof.

In accordance with another aspect, the present invention also provides a data-management system for linking a portion of an electronic document to a target document. The data-management system includes a data-capture device for capturing electronic data representing an information object, means for generating the target document from the electronic data, a computer readable memory to store the target document, and means for substantially simultaneously storing the target document in the computer readable memory and generating a link to the target document in the electronic document.

In accordance with another aspect, the present invention also provides an electronic-document-management method for creating and managing an electronic document having a link to a target document in a computer application. The method includes the steps of generating the target document from electronic data representing an information object captured by a data-capture device, and substantially simultaneously storing the target document in a computer readable memory and generating the link at said user-selected location in the electronic document.

In accordance with another embodiment, the present invention also provides an electronic-document management method for creating and managing an electronic document having a plurality of links to target documents in a computer application. The method includes the steps of generating a plurality of target documents from electronic data representing one or more information objects captured by a data-capture device, sequentially assigning each of the plurality of target documents an identifier and storing the target documents in an order according to the identifier in a computer readable memory, and substantially simultaneously generating one or more links to the target documents in the electronic document.

In accordance with another embodiment, the present invention also provides a data-management system for generating a hyperlink in real time between a portion of an electronic document opened in a computer application and a target document. The system includes a digital computer terminal comprising a computer readable memory and a data-capture device, data-capture logic in communication with the digital computer terminal for controlling capture of electronic data by the data-capture device, target-document logic in communication with the digital computer terminal for generating the target document from the electronic data, and link-generating logic in communication with the digital computer terminal for substantially simultaneously storing the target document in the computer readable memory and generating the link to the target document in the electronic document in real time.

### BRIEF DESCRIPTION OF THE DRAWINGS

FIG. 1 is an illustrative example of a personal computer system for linking an information object to a location in a document in accordance with one aspect of the present invention;

FIG. 2 is a block diagram depicting an internal arrangement of the personal computer illustrated in FIG. 1;

FIGS. 3A-3D are flow diagrams illustrating logic of a document management system offering a user the ability to substantially simultaneously capture and generate a link to a target document in an electronic document in real time;

FIG. 4 is an illustrative example of a document opened in a word processing computer application and displayed by a display device, the document including one or more locations to be linked to a target document;

FIG. 5 is an illustrative example of a document opened in a spreadsheet computer application and displayed by a display device, the document including one or more locations to be linked to a target document;

FIG. 6 is the document opened in the spreadsheet computer application shown in FIG. 5 with a TOOLS pull-down menu displayed, wherein an ATTACH DOCUMENT member of the TOOLS pull-down menu is highlighted;

FIG. 7 illustrates a MAIN MENU window of a data-management system according to an embodiment of the present invention displayed in a spreadsheet computer application by a display device;

FIG. 8 illustrates an OPTIONS window of a data-management system according to an embodiment of the present invention displayed in a spreadsheet computer application by a display device;

FIG. 9 illustrates a HYPERLINK-DOCUMENT window of a data-management system according to an embodiment of the present invention displayed in a spreadsheet computer application by a display device;

FIG. 10 illustrates a SCAN-OPTIONS window of a data-management system according to an embodiment of the present invention displayed in a spreadsheet computer application by a display device;

FIG. 11 illustrates the HYPERLINK-DOCUMENT window displayed in FIG. 9 including a preview of a target document;

FIG. 12 is the document shown in FIG. 5 including a link generated by a document management system according to the present invention linking the document shown in FIG. 5 to a target document, the link being shown in cell A9 as underlined for purposes of illustration; FIG. 12 also illustrates a PRINT window of a data-management system according to an embodiment of the present invention displayed in a spreadsheet computer application by a display device;

FIG. 13 illustrates a TOOLS window of a data-management system according to an embodiment of the present invention displayed in a spreadsheet computer application by a display device;

FIG. 14 illustrates a PREPARE-FOR-CD window of a data-management system according to an embodiment of the present invention displayed in a spreadsheet computer application by a display device;

FIG. 15 illustrates a CHANGE HYPERLINK PATHS window of a data-management system according to an embodiment of the present invention displayed in a spreadsheet computer application by a display device;

FIG. 16 illustrates a BATCH-SCAN window of a data-management system according to an embodiment of the present invention displayed in a spreadsheet computer application by a display device; and

FIG. 17 illustrates a BATCH-IMPORT window of a data-management system according to an embodiment of the present invention displayed in a spreadsheet computer application by a display device.

### DETAILED DESCRIPTION OF AN ILLUSTRATIVE EMBODIMENT

FIG. 1 shows an example configuration of a digital computer 10 that can be used to implement the present invention. Included as part of the digital computer 10 configuration is a display device 14, a central processing unit 18, a keyboard 22, a mouse 24 and a data-capture device 26 illustrated as an optical scanner. The keyboard 22, mouse 24 and data-capture device 26 are among a group of input devices that can be operatively coupled to the digital computer 10 for providing data to, and controlling operation of said digital computer 10. Although the digital computer 10 is shown in FIG. 1 in a desktop configuration, other configurations including a notebook computer or any other portable computing device (not shown) provided with a portable data-capture device can also be used without departing from the scope of the present invention. Similarly, the data-capture device 26 can be an optical scanner as shown in FIG. 1, or, the data-capture device 26 can be any other device, whether digital or analog, capable of capturing a visible image, audible sound, and other observable information object as electronic data to be processed by the digital computer 10 into a target document. Examples of other suitable data-capture devices 26 include, but are not limited to digital cameras, video cameras, microphones, magnetic resonance imaging devices, telephones, cellular phones, and the like. Further, the data-capture device 26 can communicate with the digital computer 10 via a cable connection, a wireless connection, or both. The data capture device can also optionally furnish its own power or utilize the power of the digital computer when connected directly to the digital computer via a USB port connection.

As used herein, the term information object refers to any object that can be observed, can be the subject of an observation, or can otherwise provide information that can be captured by the data-capture device 26. Observations of an information object are to be captured by the data-capture device 26 and converted into electronic data. For example, a receipt, bill, file, certificate, record, and other tangible documents can be information objects because they can be scanned and converted into electronic data that will be used to generate an electronic version of those tangible items. Similarly, a train, mountain, bird, and any other object that can be photographed or filmed by a digital camera or a movie camera, respectively, can be an information object. In such cases, an image of those objects can be captured by the data-capture device 26 and converted into electronic data that will also be used to generate an electronic image, or representation of those items. Further, sound producing items can be information objects as their sounds can be recorded by the data-capture device 26 and converted into an electronic sound file. The electronic version of tangible items, the electronic image, or representation of, an item, the sound file, and any other electronic file generated from electronic data captured by the data-capture device 26 will be referred to generally herein as a target document.

While several examples of information objects have been provided herein, this list is by no means exhaustive. For purposes of this disclosure, however, an illustrative embodiment will be described below with reference to a data-capture device 26 in the form of an optical scanner, and an information object in the form of a tangible document in light of the preceding discussion. A tangible document is a sheet of paper or other documentary material with printed information thereon that can be held and placed on a scanner. Examples of tangible documents include, but are not limited to, a receipt, bill, file, certificate, record, page of a bound volume of reading material, and other such documentary items.

Optical scanners 26 are well known in the art for capturing tangible documents as electronic data to be processed by the digital computer 10. The electronic data is used by the digital computer 10 to create an electronic representation of the tangible document, where, as mentioned above, said electronic representation of the tangible document will be referred to herein as a target document. Generally, optical scanners 26 are devices that include an imaging device (not shown) disposed within a housing 29. The tangible document is brought within close proximity to the imaging device and is either transported through a line of sight of the imaging device, or, is held stationary while the imaging device is passed along the length of the tangible document. In both cases, the imaging device is exposed to the tangible document to capture electronic data that will be used by the digital computer 10 to generate the target document.

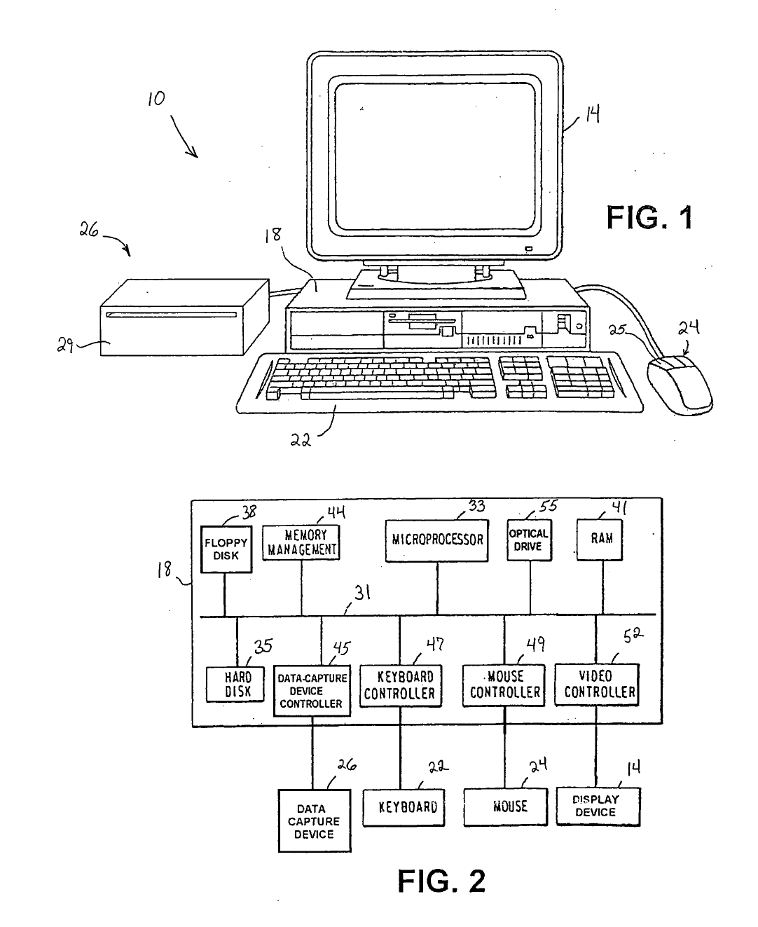

FIG. 2 illustrates an example internal arrangement of the digital computer 10. A system bus 31 serves as a communication channel between components of the central processing unit 18. A microprocessor 33 is operatively coupled to the system bus 31 and is supported by a read-only memory (ROM) (not shown) that stores code for controlling the interaction between the various components of the digital computer 10. Information flow between a hard disk 35, floppy disk 38 and random-access memory (RAM) 41, and other components is governed by a memory management device 44. The devices mentioned above, namely, the keyboard 22, mouse 24 and data-capture device 26 allow the user to input information into the digital computer 10, while controllers 45, 47 and 49 provide an interface between the digital computer 10 and the data-capture device 26, keyboard 22 and mouse 24, respectively. Similarly, a video controller 52 couples the display device 14 to the system bus 31 to permit the transmission of display data to the display device 14. An optical drive 55 is also provided to the digital computer 10 for recording data on optical recording media such as a compact disk (CD), digital versatile disk (DVD) and the like. This hardware, shown in FIG. 1 and FIG. 2, is typical for implementing software of the present invention, but may vary for specific applications that require other peripherals and internal components.

The operation of the components described above is coordinated by an operating system which includes computer readable code, also referred to as logic, which is conventionally retained within the hard disk 35. In addition to coordinating the operation of the various hardware components, the operating system provides a platform from which computer applications can be launched and displayed by the display device 14. Computer applications pertaining to the present invention include all such applications for creating, viewing, or editing electronic documents, or any combination thereof. Examples of such applications include, but are not limited to word processing applications, spreadsheet applications, database applications, presentation applications, publishing applications, financial planning applications, web browser applications, and the like. It follows, then, that the term electronic document means any electronic document that can be opened by the computer application and is to include the subject matter to be linked to a target document. The electronic document will include at least one of an overview, summary, contents of a report, index, table of contents, list of objects, and the like, while the one or more target documents linked to the electronic document can be considered as underlying, secondary, supplemental, and other similar documents. The present invention is directed toward enhancing computer applications and a logic-based system to implement the enhanced applications for generating a link between the electronic document and a target document in real time. By real time it is meant that a link is generated at about the same time as the electronic data used to generate the target document is captured. Capturing the electronic data, generating the target document and generating the link are performed within the framework of the computer application in which the electronic document is opened.

As used herein, the term link refers to a relationship between the portion of the electronic document and at least one target document. Activating the link retrieves the target document, causing it to be displayed by the display device 14 or otherwise presented to a user by the digital computer 10. An example of a link of the present invention is what is commonly referred to as a hyperlink. Generally, a hyperlink is visually represented as a graphical image or icon within the electronic document which has been associated with a command containing an address, path, or location, where the target document is stored. This hyperlink, at the option of the operator of the system, can be displayed as the full path to the target document, however, hyperlinks will generally be represented by a word or phrase. The command, which can be executed by pointing and clicking on the link with a curser with the aid of a mouse, is most commonly written in Hypertext Markup Language (HTML), but can also be written in other suitable languages, such as C, Basic, Java, Assembler, and the like. Regardless of the graphical representation of the link and language used to program the command, a link can be created to link the portion of the electronic document to any type of target document. Thus, the target document can include a captured image, text document, sound recording, video recording, and any combination thereof created from electronic data captured by the data-capture device 26 as discussed above. The type of target document to be generated will determine the appropriate data-capture device 26 to be employed. For example, if the target document is to be an electronic version of a text document, an optical scanner is an appropriate data-capture device 26. If the target document is to be a sound file, the appropriate data-capture device 26 would be a microphone. Similarly, if the target document is to be a photo, a digital camera or other imaging device would be the appropriate data-capture device 26.

Additional examples of the types of links contemplated by the present invention include OLE fields within a database computer application such as that marketed under the tradename Access by Microsoft Corporation. Particular fields within the database computer application can be designated as an OLE object in which an image, spreadsheet, text document, sound file, video file, and the like can be inserted. A duplicate of the object inserted into the OLE object field is embedded within, and linked to, the database. As a copy, changes to the original object are not automatically reflected in the duplicate.

Similarly, a field designated as data type Binary Large Object (“BLOB”) accepts binary data describing an object in its entirety, without any restructuring of the data. Any computer application accessing the BLOB data for display purposes must be able to interpret this data. If the binary data is a TIFF image, for example, then the computer application must be able to read the data structure of the TIFF image.

Upon the operator's selection of the link, the target document is retrieved and displayed by the display device 14, which, according to the illustrative embodiment shown in FIG. 1, is a computer monitor. Alternately, if the target document is a sound file, activating the link retrieves the sound file, which is presented audibly to the user by the digital computer 10 via speakers (not shown). The target document may be displayed in the same window as the electronic document, in its own window which is opened to display the target document, or in any other manner. Further, since the target document can take any form or format, including those described above, the target document may be opened in the same computer application in which the electronic document it is linked to is running, or, it may be opened in another computer application. If the target document is opened in another computer application, the other computer application is automatically launched to display the target document upon activation of the link. If, however, the target document is to be opened by the same computer application in which the electronic document is opened, the target document can be opened in a new window, as a new electronic document, and in any other manner.

For example, consider an electronic document in the form of a spreadsheet being edited in a conventional spreadsheet computer application and a target document in the form of an image. Activation of a hyperlink embedded in the spreadsheet to the image would cause an image-viewing program to be launched by the computer 10 and the image displayed. Similarly, if the target document had been another spreadsheet, the same spreadsheet computer application could open an additional window to display the spreadsheet target document upon activation of the hyperlink.

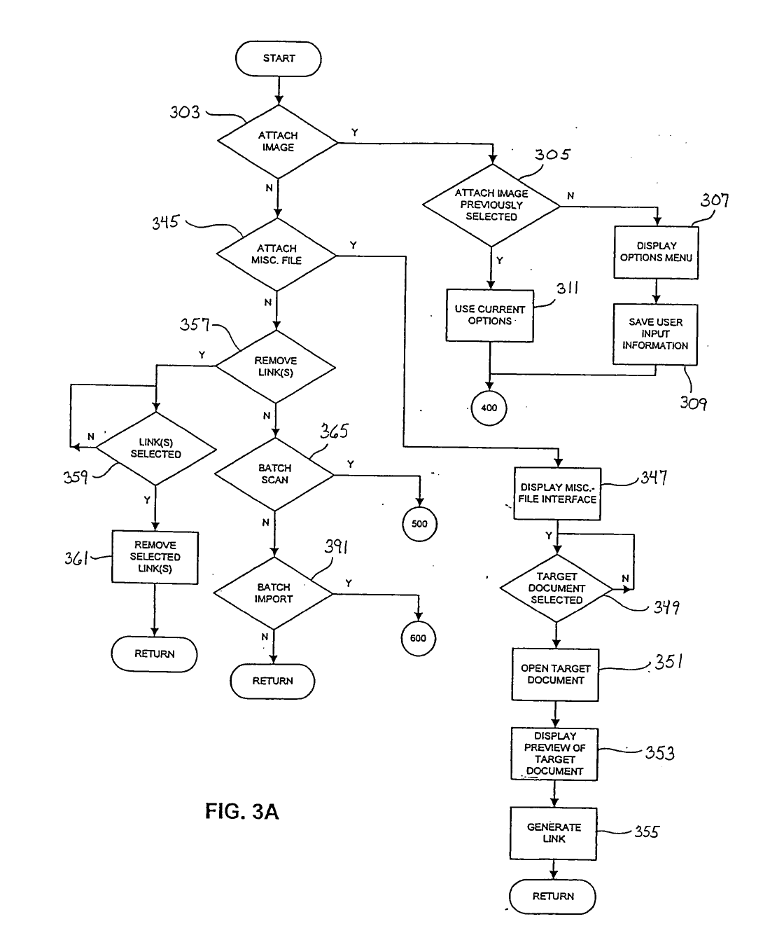

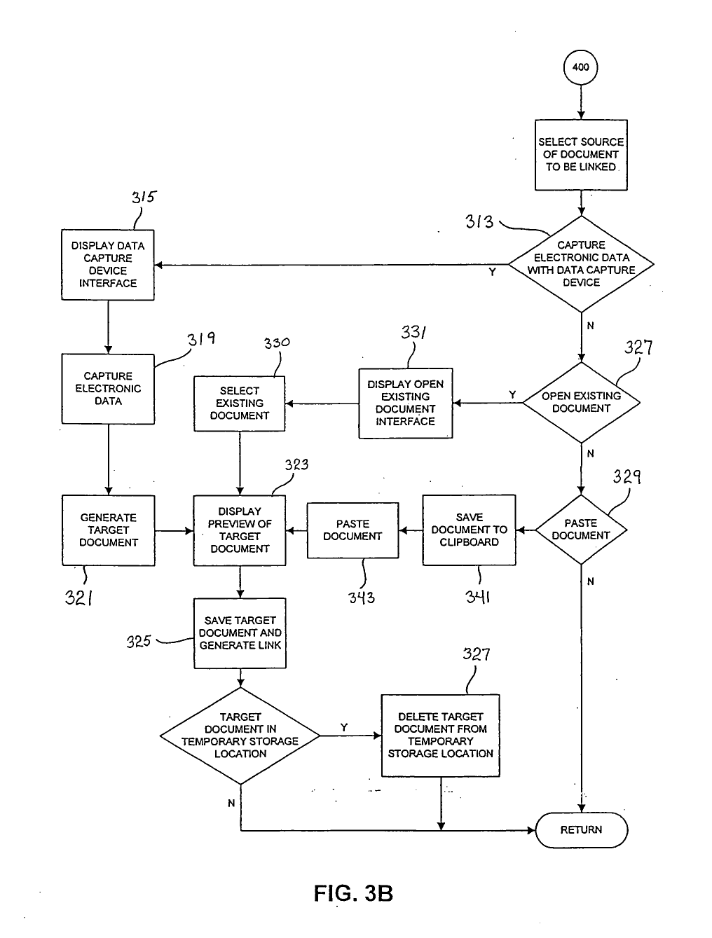

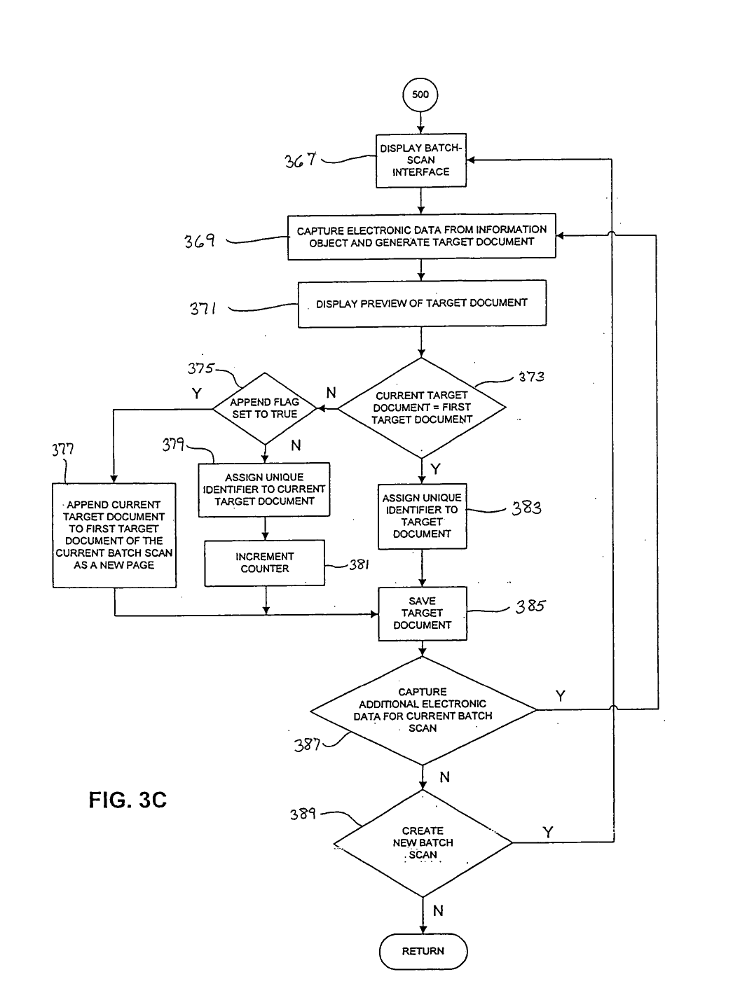

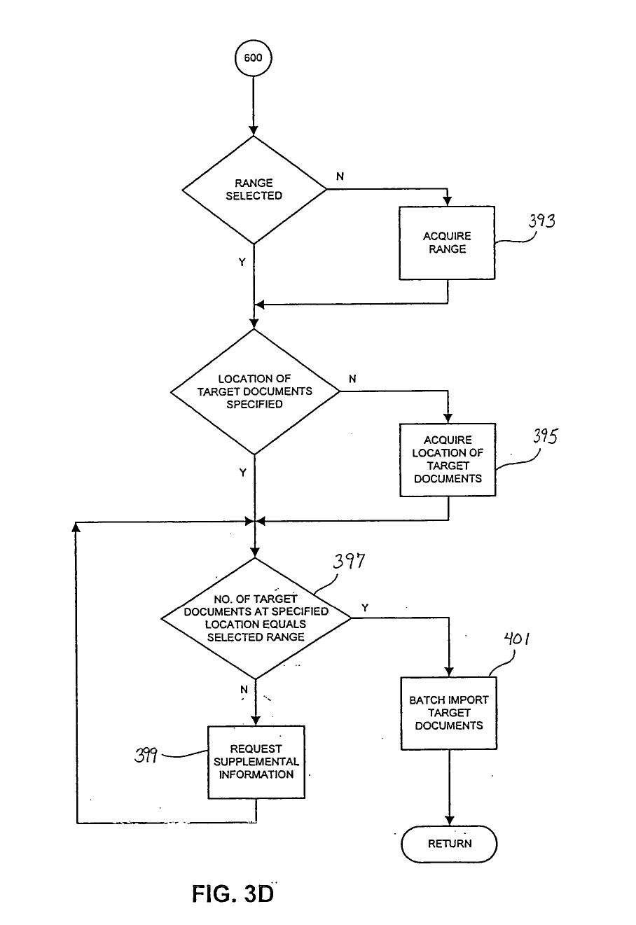

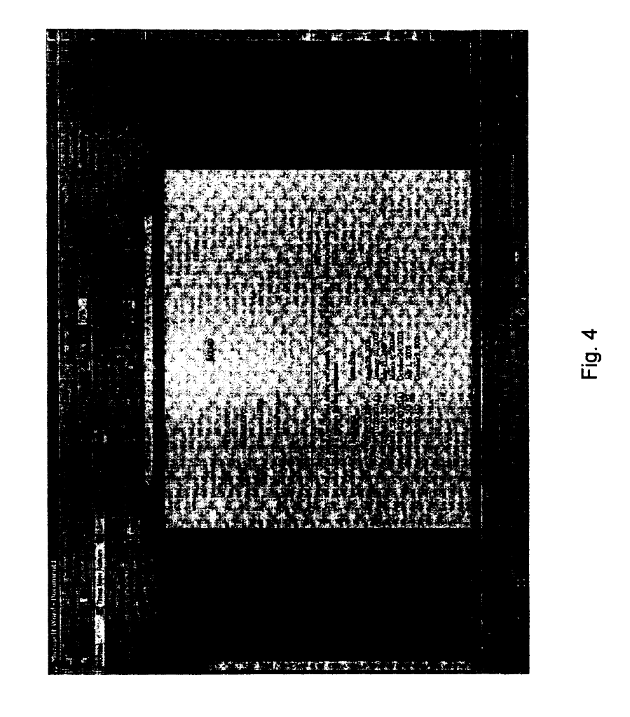

Having described the basic digital computer 10 configuration, operation of a data-management system (DMS) 100 according to the present invention will be described by way of example in terms of the illustrative embodiment. FIGS. 3A-3D show a general flow diagram of the DMS 100 according to the illustrative embodiment of the present invention. The DMS 100 can be a body of computer readable logic in a variety of embodiments including: an add-in to be added to an existing computer application to enhance that existing computer application, integrated into the computer application itself, and programmed into a piece of hardware included as part of the digital computer 10. Regardless of the method in which it is implemented and provided to the computer application, the DMS 100 operates generally as described below. In order to clearly explain the present invention, however, the illustrative embodiment will be used as an example implementation throughout this disclosure. The illustrative embodiment comprises a DMS 100 provided as an add-in to a spreadsheet computer application such as that marketed under the tradename Excel by Microsoft Corporation. From this discussion, it should also be clear that the DMS 100 can be implemented in other computer applications such as word processing applications, database applications, presentation applications, publishing applications, financial planning applications, web browser applications, and the like. It is further contemplated that the DMS 100 can be provided to an entire package of computer applications such as that marketed under the tradename Office by Microsoft Corporation.

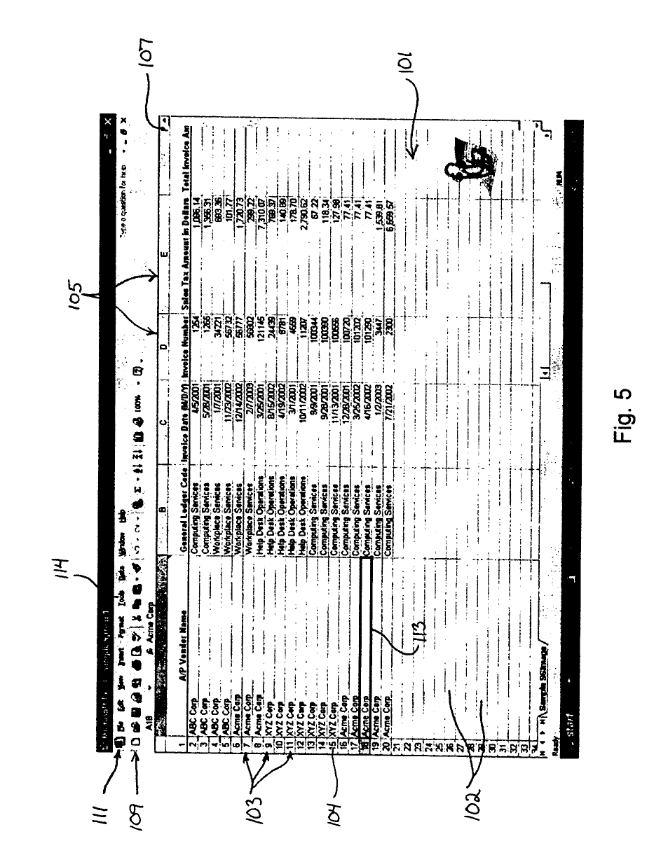

In FIG. 5, a screen of a well known spreadsheet application is shown to include a data field 101 divided into cells 102 by a series of intersecting rows 103 that are identified by a reference number 104 along the left margin, and columns 105 that are identified by a reference character 107 at the top of each column 105. Individual cells are identified according to the reference number 104 of the row 103 and the reference character 107 of the column that intersect at a particular cell 102. Currently selected cells 102 are outlined by a bold border 113 that can be dragged and resized to select a range of cells 102. In FIG. 5, for example, the cell 102 identified as “A18” is currently selected. A toolbar 109 and a menu bar 111 are provided outside and above the data field 101, allowing a user to scroll the data field 101 to display a cell located outside of the visible range in FIG. 5 without concealing the toolbar 109 and the menu bar 111.

If the DMS 100 has not already been provided to the spreadsheet application that is operable on the digital computer 10, it is to be installed as an add-in, which is defined herein as a supplemental piece of software to be provided to the spreadsheet, or other computer application originally developed without the supplemental piece of software. As the name suggests, the supplemental piece of software referred to as the add-in is to be installed on a digital computer 100 following installation of the spreadsheet application. Again, as mentioned above, the installation of the add-in for use with a spreadsheet application is merely an example. An add-in can be installed for use with any of the computer applications described above.

The DMS 100 includes data-capture logic for controlling capture of electronic data by the data-capture device 26, target-document logic for generating the target document from the electronic data, and link-generating logic for substantially simultaneously storing the target document in the computer readable memory and generating the link to the target document in the spreadsheet in real time. Again, the DMS 100 controls the capture of the electronic data and the generation of the link to the target document generated from the captured electronic data within the framework of the spreadsheet computer application.

The process of installing a piece of software is well known in the art, and thus, a detailed description of the installation process is omitted. In the illustrative embodiment, it is noted that the DMS 100 is to be installed as an add-in that will be provided as an option that can be selected from the TOOLS menu 114 on the menu bar 111. However, the DMS 100 is not limited to being installed as an option in the TOOLS menu 114 only, but can be installed for selection from any menu item, or can be activated from a button provided to the toolbar 109 for example.

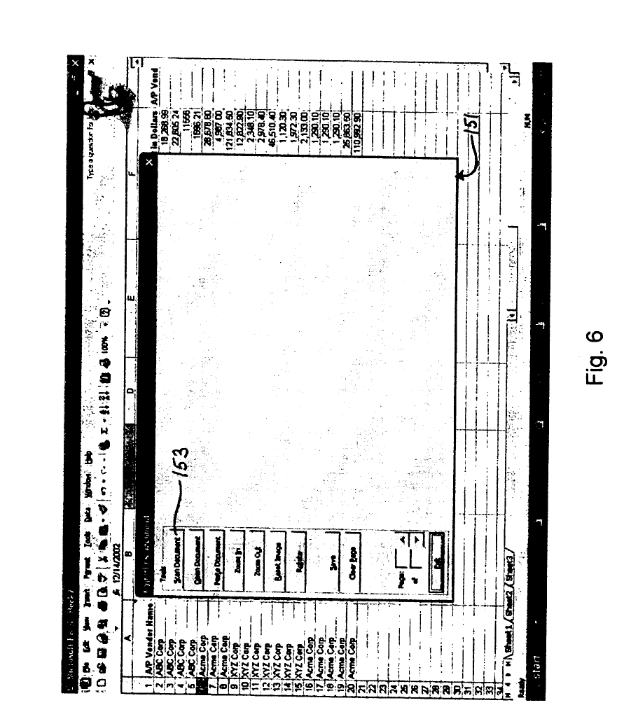

Once the DMS 100 is installed, it can be activated from the TOOLS menu 114 by “pulling down” the TOOLS menu 114 and selecting the ATTACH DOCUMENT option 117 from the pull-down menu as shown in FIG. 6. This is typically done by placing a cursor (not shown) over the TOOLS menu 114 with the mouse 24, and pressing a leftmost button 25. Since pull down menus may be layered, this option can alternately be provided under another available option.

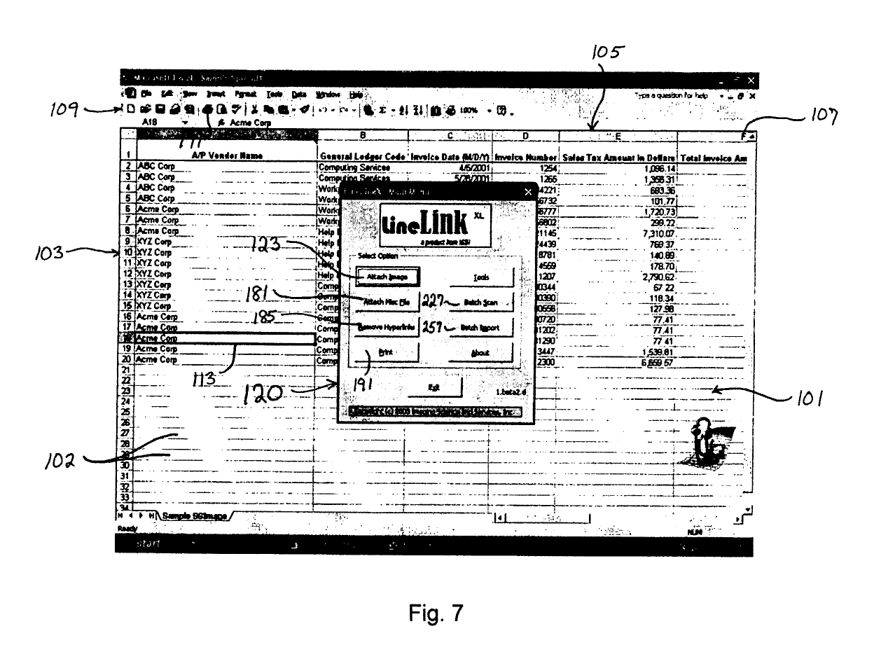

Upon selecting ATTACH DOCUMENT 117 from the TOOLS menu 114 with the mouse 24, the user is directed to a main window 120 of the DMS 100, shown best in FIG. 7. The main window 120 includes options for creating one or more links to a target document and options for managing the links to the target document. Each option can be offered as a menu item, a button, and any other item that can be selected by the user. The first option provided by the DMS 100 to be discussed herein is the option to create a link in the electronic document to a target document in real time. To select this option, an ATTACH IMAGE option 123 is to be selected from the main window 120 and is shown in FIG. 3A as step 303. Although the title of the option 123 is ATTACH IMAGE, it should be noted that the target document to be linked via the ATTACH IMAGE option 123 does not necessarily have to be an image. The target document to be attached via this option can be an image, a text document (i.e., a text document created through optical character recognition), sound recording, video recording, and any combination thereof created from electronic data captured by the data-capture device 26.

The main window 120, as with all windows of the illustrative embodiment described herein, may be a modal window or a non-modal window, meaning that the main window 120 will not, or will, allow another window to be opened in front of it, respectively. Although modal windows will not allow another window to be opened in front of the modal window, the modal windows of the present invention permit the user to select items with the mouse 24 in the data field 101 displaying the electronic document while the modal windows are open. Further, the windows and computer applications discussed herein all provide a user with a graphical user interface (GUI), however, the present invention contemplates alternate data entry and presentation methods other than the GUI.

Selecting the ATTACH IMAGE option 123 at step 303 begins the process of capturing electronic data to create the target document and generate a link to the target document in real time. By “real time” it is meant that the link to the target document is created at approximately the same time as the electronic data is captured and saved to a computer readable memory. The real-time nature of the ATTACH IMAGE option offers the user the ability to generate a link directly to a target document as that target document is being created and saved as electronic data in the computer readable memory. This eliminates the requirement for a target document to exist as electronic data before beginning the process of creating a link to the target document in the electronic document. Thus, the conventional stepwise procedure of capturing electronic data to create a target document, saving the target document to a memory device, and only then retrieving that target document at a later time to create a link in an electronic document is avoided. According to the illustrative embodiment of the present invention, the DMS 100 substantially simultaneously generates a link to a target document at a desired location in an electronic document and saves the target document in a computer readable memory.

If the spreadsheet is a new, blank document, a link can still be generated in real time. In this case, the spreadsheet application will be launched and a new document created. Once the target document has been generated a link is created in the new document to the target document. The link is represented graphically in the new spreadsheet by a listing of the full file path in the new document since there are no other items to which the link can be provided.

The computer readable memory discussed in the preceding paragraph can be any memory for storing electronic data that can be accessed by the digital computer 10. For example, with reference to FIG. 1, the computer readable memory includes the floppy disk 38, optical disk such as a CD and a DVD for use in optical drive 55, RAM 41, hard disk 35, and the like.

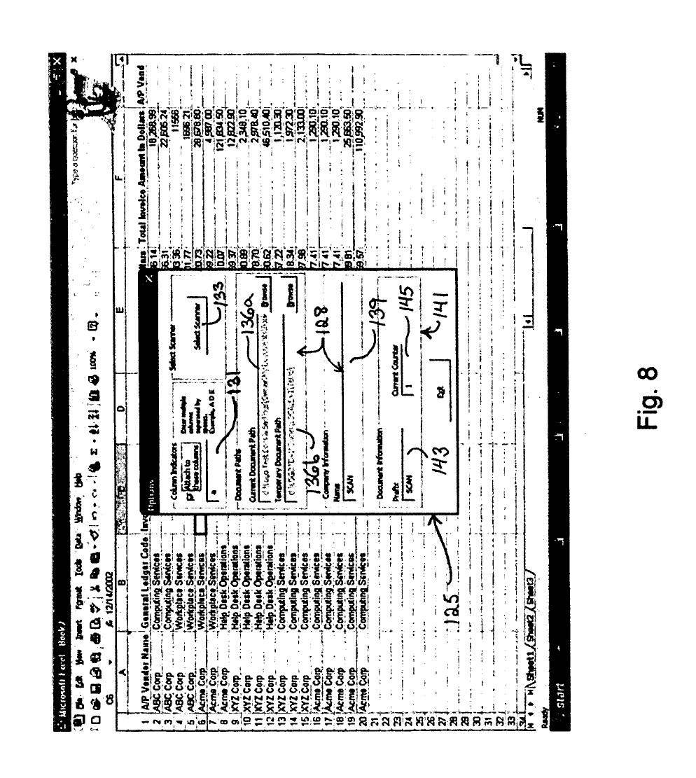

Referring again to FIGS. 3A and 7, the first time that the ATTACH IMAGE function is activated by selecting the ATTACH IMAGE button 123 from the main window 120, as determined at step 305 in FIG. 3A, the user is prompted to input preferences on storing electronic data and one or more target documents to be linked to one or more portions of the spreadsheet. One way of prompting the user and entering the user's preferences into the DMS 100 according to the present invention is by displaying an OPTIONS window 125 at step 307, the OPTIONS window 125 being shown in FIG. 8. The OPTIONS window 125 includes various data fields 128 in which the user is to provide information concerning the desired location(s) in the electronic document where a link is to be inserted, and information concerning where and how electronic data representing the target document(s) captured by the data-capture device 26 is to be stored. Default values are inserted into the input fields 128 in the absence of the user inputting a desired entry into one or more of the input fields 128. The OPTIONS window 125 can also include a scanner-selection button 133, which is discussed below.

The exemplary OPTIONS window shown in FIG. 8 includes a column-indicator field 131 allowing the user to specify one or more columns 105 in which a link to a target document is desired. By inputting more than one column 105 in the column-indicator field 131 the user can simultaneously insert identical links in cells 102 in a plurality of columns 105. By way of example, suppose the user has selected cell C6 as shown in FIG. 8. The only column 105 specified in the column-indicator field 131 of the OPTIONS window 125 in FIG. 8, however, is column a. According to this example, a link to a target document will be generated in cell A6. Now, suppose for example that the user has selected cell C6 with the mouse 24 and has input both column A and column C in the column-indicator field 131. According to this example, a link to the target document will be generated in cell A6, and a link to the same target document will be generated in cell C6 simultaneously.

Although the illustrative embodiment has been described as selecting columns 105 in the OPTIONS window 125 and selecting rows 103 with the cursor position, other arrangements are also within the scope of the present invention. Arrangements where the rows are specified in the OPTIONS window 125, where the desired link locations are selected based on cursor-selected locations, and any other similar arrangements are also within the scope of the present invention. The other arrangements can be employed to implement the DMS 100 according to the present invention in any of the aforementioned computer applications as appropriate.

A Current Document Path field 136a and a Temporary Document Path field 136b are provided in the OPTIONS window 125 to allow the user to specify a path of desired permanent and temporary storage locations, respectively, for the electronic data that is to be captured. A path, as the name suggests, is a pathway to a storage location in the computer readable memory where a target document can be stored, or is already stored, and from where the target document can be retrieved. The user is provided with the option to browse, and select from, existing storage locations available in the computer readable memory. Again, default entries are present in these fields 136a and 136b in the absence of a user-input entry. The default paths direct data to storage locations that are commonly included on the hard disk 35 of the digital computer 10.

A Company-Information field 139 is provided to allow the user to input a client for whom work is being done, a project code, and any other information to identify the subject matter of the electronic document. It is merely a convenience to be utilized by the user in managing the electronic document and any target documents. Information input into the Company Information field 139 will not have any bearing on the storage of any target documents or the. generation of any links as described below.

A Document Information section 141 of the OPTIONS window according to the illustrative embodiment shown in FIG. 8 includes two input fields: a Prefix field 143 and a Current-Counter field 145. Into the Prefix field 143, a user can enter a title to be used in saving captured electronic data into the computer readable memory. The title entered into the Prefix field 143 will form a first portion of an identifier, such as a file name, to be assigned by batch-control logic of the DMS 100 to a target document created from the captured electronic data. The identifier of each target document will identify the target documents stored in the computer readable memory. Batch-control logic provided to the DMS 100 is computer readable code that includes instructions for controlling the assignment of identifiers to scanned, and otherwise captured, target documents. The batch-control logic combines information from the Prefix field 143 with incremental counter information described below to create the identifier.

A number input to the Current-Counter field 145 will form a second portion of the identifier of a target document to be saved in the computer readable memory. When a first tangible document is scanned, a target document created from electronic data captured by the scanner 26 will be saved in the computer readable memory as a file having a name with the number specified in the Current-Counter field 145 as the second portion. As each subsequent tangible document is scanned, the value in the Current-Counter field 145 is incremented by one (1) by a counter, thereby providing the batch-control logic with information for assigning a unique identifier to each subsequently scanned, or otherwise captured, target document. This incremented value will form the second portion of the identifier for each subsequent target document created by scanning subsequent tangible documents. By way of example, with the information shown in FIG. 8 entered into the DMS 100, the first tangible document that is scanned will be saved as a target document in the computer readable memory under the name SCAN0001. A second tangible document scanned will be saved in the computer readable memory under the name SCAN0002. Likewise, a third tangible document scanned will be saved in the computer readable memory under the name SCAN0003. This sequential manner of storing scanned documents in the computer readable memory continues until the value in the Prefix field 142 or the Current-Counter field 145, or both, is reset by the user.

The Select-Scanner button 133 allows the user to select a device to be used to capture electronic data into the DMS 100. In the illustrative embodiment, the user can select a scanner from among those available to the digital computer 100 in a SELECT SOURCE window 147 as shown in FIG. 8b. If a desired scanner does not appear as an option, the user can install a new scanner for use with the digital computer 100 in a well-known manner, and then return to the SELECT SOURCE window 147 and select the newly installed scanner. The scanner 26 selected by the user will instruct the DMS 100 as to which scanner-specific software package to call for controlling the scanning function as discussed below.

The above description of a system and method of entering user preferences into the DMS 100 is for purposes of illustrating an embodiment of the present invention. They are not the only system and method within the scope of the present invention, but provide a convenient and orderly user interface for entering this information. Accordingly, any system and method of entering a user's preferences into the DMS 100 can be used without departing from the scope of the present invention.

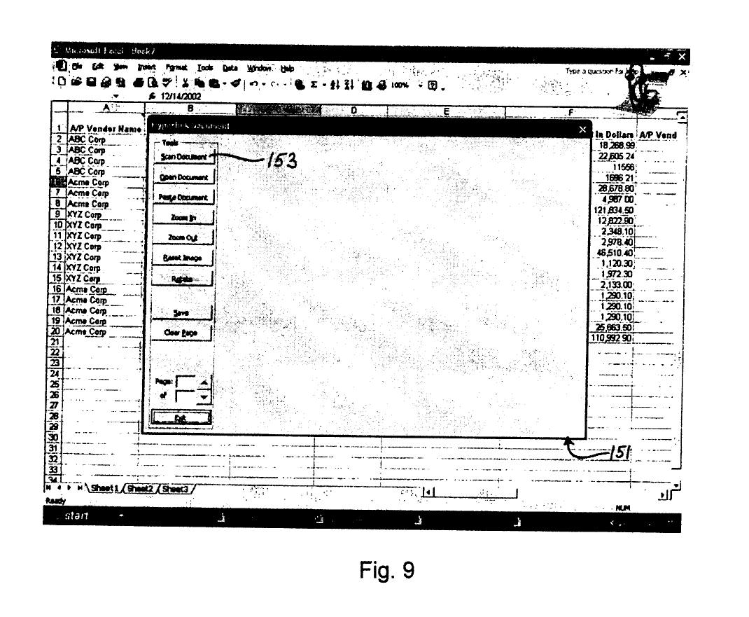

With the user's preferences entered into the DMS 100 the first time the ATTACH IMAGE option is selected in a particular spreadsheet, the DMS 100 saves the user-input information at step 309, said user-input information being used as the default information during subsequent ATTACH IMAGE functions at step 311. After saving the user input information, the DMS 100 proceeds to a Hyperlink-Document window 151, best shown in FIGS. 9-11 and having a flow diagram of operation shown in FIG. 3B. This window also presents the user with a GUI for controlling operation of the DMS 100. Staying with the illustrative embodiment where a tangible document is to be scanned and linked to a location in an electronic document opened in a spreadsheet computer application, a Scan-Document button 153 selected with the mouse 24 at step 313 calls the data-capture logic for controlling the scanning operation. Data-capture logic is a set of computer readable instructions for calling a scanner-specific software package, including scanner-control logic, and otherwise controlling the capture of electronic data by the data-capture device 26. The particular scanner-specific software package called depends on the scanner selection made by selecting the Select-Scanner button 133 with the mouse and choosing the desired scanner in the Select Source window 147 (FIG. 8b).

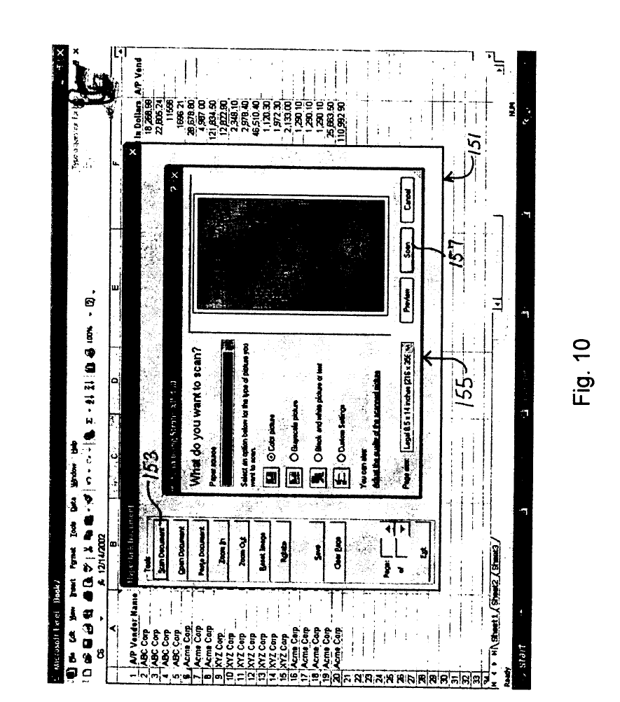

The scanner-specific software package is typically a piece of proprietary software that is developed by the manufacturer of the scanner and included with a scanner that is purchased new, or, that can be downloaded from a network such as the Internet. FIG. 10 shows the illustrative embodiment of the DMS 100 of the present invention displaying a data-capture-device interface window 155, according to step 315 in FIG. 3B, generated by a scanner-specific software package provided by Visioneer Inc. This particular scanner-specific software package allows the user to select a location from where the tangible document is to be introduced to the scanner 26, the type of image to be scanned, and the desired print quality of the soon-to-be-captured target document. Selecting the Scan button 157 activates the scanner 26 of the illustrative embodiment at step 319, thereby beginning the capture of electronic data that is to be used for creating the target document.

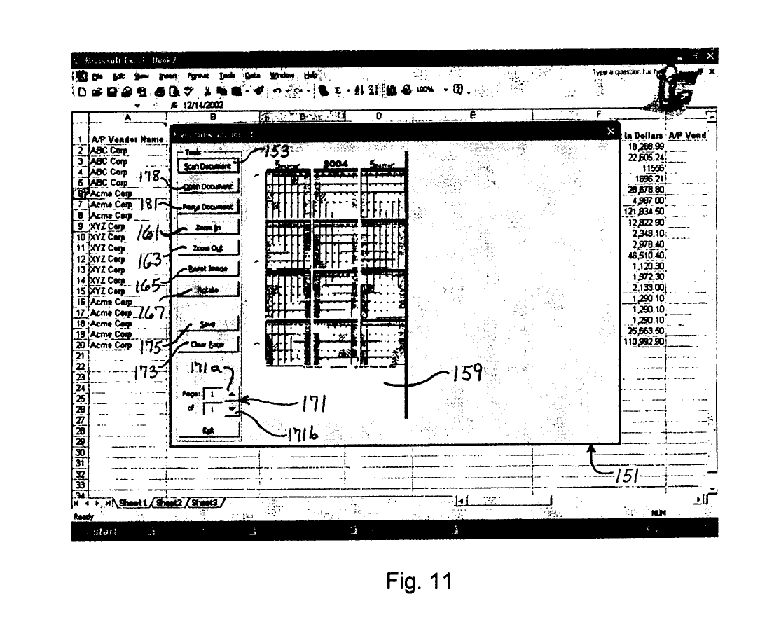

A preview 159 of the target document generated, at step 321 in FIG. 3B, by target-document logic from electronic data captured by the data-capture device 26 can be displayed at step 323 as shown in FIG. 11 in the HYPERLINK DOCUMENT window 151 before being saved in the computer readable memory. Similar to the data-capture logic, the target-document logic is a set of computer readable instructions for generating the target-document from the captured electronic data. Other target document viewing and editing tools can also be made available to the user in this window 151. Examples of the other target document viewing and editing tools provided to the illustrative embodiment of the DMS 100 include a Zoom-In option 161, Zoom-Out option 163, Reset-Image option 165, and Rotate option 167. These options are well-known in the art, and don't require a lengthy description herein. It will suffice to say that the Zoom-In and Zoom-Out options 161, 163 zoom in or out on the preview 159 of the target document, making items in the displayed target document appear larger and smaller, respectively. The Reset-Image option 165 returns the displayed target document to its originally captured state from a zoomed in/out state, a rotated state, or an otherwise altered state. The Rotate option 167 rotates the preview 159 of the target document in the Hyperlink-Document window 151. Finally, a Clear Page option 173 is offered to allow the user to discard a previewed target document that is unacceptable to, or no longer desired by the user. Selecting the Clear Page option 173 removes the previewed target document from the temporary storage location and the preview window.

Once the first tangible document has been scanned, the user can optionally scan a second tangible document that will form a second page of the target document. In this manner, the user can create a link in an electronic document that can be activated to retrieve the two-page target document including an electronic version of both the first and second tangible document. Similarly, a third tangible document, a fourth tangible document, and so on, can be scanned to create a three page and a four page target document that can be retrieved by activating one link. A page manager 171 allows the user to preview each page of the target document by selecting an increment option 171a and a decrement option 171b. Should the user determine that one or more pages of the target document being previewed are unacceptable or are otherwise undesired, the user can again select the Clear-Page option 173 to delete the currently displayed page of the target document. After deleting all unacceptable and undesired pages of the target document, the user can select a Save option 175, causing link-generating logic to substantially simultaneously store the target document in the computer readable memory and generate the link to the target document in the electronic document at step 325. Link-generating logic is a set of computer readable instructions that control the computer 10 to for substantially simultaneously storing said target document in said computer readable memory and generating the link or links to the target document in the electronic document. Once the Save option 175 has been selected and the target document has been saved in the permanent storage location, the target document is removed from the temporary storage location at step 327.

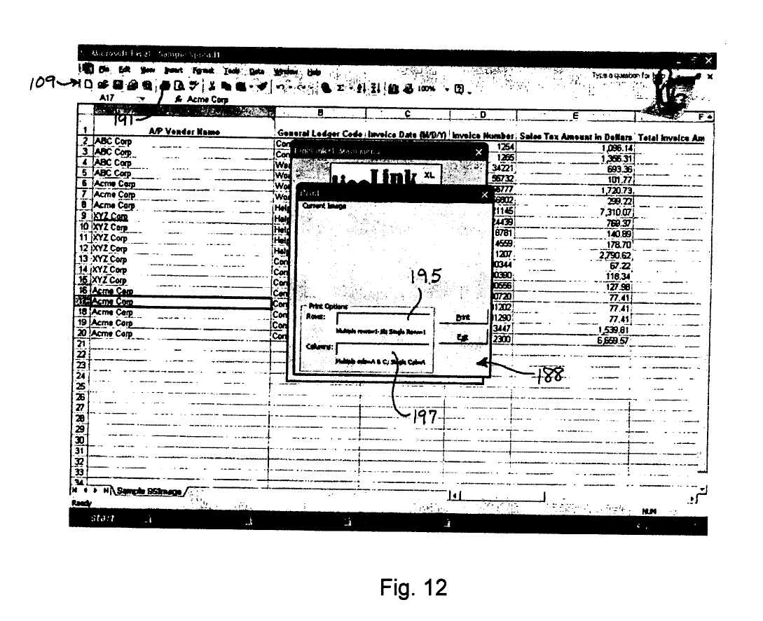

Substantially simultaneously storing the target document in the computer readable memory and generating the link to the target document in the electronic document means that the storing of the target document and the generation of the link occur without requiring the user to manually perform both tasks, individually. It is not necessary for the storing of the target document and the generation of the link to occur at precisely the same time such that they occur simultaneously in the purest sense of the word. One task can be performed after the other so long as a command by the user, such as the selection of the Save option 175 according to the illustrative embodiment, can bring about the storing of the target document and the generation of the link. The link generated according to the illustrative embodiment can be seen in cell A9 in FIG. 12. The link has been attached to the contents of cell A9 and can be identified from the underlined text that now appears in a blue color. This form of visual indicia to identify a link in an electronic document is merely an example of the numerous types of visual indicia that can be used for this purpose. An icon, a distinctive color, a distinctive font, etc. . . can also be used to identify the presence of a link.

At this point it should be noted that scanning a second, third, fourth, etc. . . number of tangible documents to create a two, three, four, etc. . . page target document, respectively, is distinct from batch scanning a plurality of documents that are to be continuously captured and sequentially saved in the computer readable memory. Scanning a plurality of tangible documents as described in the preceding paragraph will create a single target document having a plurality of pages. In contrast, batch scanning a plurality of documents as will be described later in this disclosure creates a plurality of target documents, each having a single page, or a single target document having a plurality of continuously and sequentially captured pages.

There are other options available to the user to generate a link in an electronic document to a target document that already exists electronically in the computer readable memory. These options include an Open-Document option 178, offered at step 327, and a Paste-Document option 181 offered at step 329 of the flow diagram in FIG. 3B. The Open-Document option 178 allows the user to generate a link to an existing document in the form of an image that has been previously stored in the computer readable memory. The existing image document, once selected at step 330 from an open-existing-document interface displayed at step 331, can be previewed in the HYPERLINK DOCUMENT window 151 at step 323 in much the same way as the scanned target document can be. Again, opening additional documents in this manner will create a target document comprising a plurality of pages, each of said pages being an existing document opened as described above. The previewed target document can be reviewed, and again removed from the preview window by selecting the Clear Page option 173. Although the Clear Page option 173 removes the existing image document from the preview window, thereby removing it from the target document to be linked, the existing image document is not deleted from its current storage location upon selection of the Clear Page option 173. Selecting the Save option 175 will generate the link to the existing image document in the electronic document.

The Paste-Document option 181 allows the user to paste contents of volatile memory commonly referred to as a “clipboard” at steps 341 and 343 into the HYPERLINK DOCUMENT window 151 to be linked to a portion of the electronic document. The process of pasting information stored in the clipboard is well known in the art, thus eliminating the need for a lengthy discussion herein. Again, pasting additional contents from the clipboard in this manner will create a pasted document comprising a plurality of pages. Selecting the Save option 175 will generate the link to the pasted document in the electronic document.

Referring back to FIGS. 7 and 3A, An Attach-Misc-File option 181 is made available to the user in the main window 120 at step 345. As the name suggests, the Attach-Misc-File option 181 facilitates the linking of a miscellaneous document that already exists in an electronic format. The miscellaneous document can be any type of document including those discussed above, as well as documents other than the types of documents discussed above with regard to the Attach-Image option 123. Such miscellaneous documents include electronic files created with a word processor application, spreadsheet application, database application, presentation application, and other such files. Upon selection of the Attach-Misc-File option 181, a menu is presented to the user at step 347 of FIG. 3A via the display device 14 in a well-known manner. The user is allowed to browse the contents of computer readable memories associated with the digital computer 10 implementing the DMS 100, select and open a miscellaneous document at steps 349 and 351 respectively, preview the selected miscellaneous document at step 353, and generate the link to the miscellaneous document at step 355.

A Remove-Hyperlinks option 185 is also included, at step 357 in FIG. 3A, in the main window 120 of the illustrative embodiment of the present invention shown in FIG. 7. The Remove-Hyperlinks option 185 utilizes link-removal logic to remove all links within a user-selected range in the electronic document at steps 359 and 361. Link-removal logic is a set of computer readable instructions for removing a link from within a predetermined range in the computer application without removing the displayed item to which the removed links were provided. In other words, when the links are removed, the visual indicia indicating the presence of a link is removed from the electronic document. Although the links and the visual indicia are removed with this option 185, the text to which the links were provided remain unchanged. By way of example, if the link created in cell A9 in FIG. 12 were removed via the Remove-Hyperlinks option 185, the underlining and the blue coloration of the text would be cleared, and the text, XYZ Corp would be returned to the font selected for text at that location in the electronic document.

FIG. 12 also illustrates a Print window 188 generated in response to the user selecting a Print option 191 from the main window 120 shown in FIG. 7. Admittedly, computer applications in which electronic documents can be opened include a printing function that can be activated by selecting an appropriate item from a menu 11 or toolbar 109 such as icon 193 in the toolbar 109. The printing function of the computer application activated by the icon 193 generates a hardcopy output of the electronic document, including any visual indicia indicating the presence of links in the electronic document. In contrast, the Print option 191 selected from the main window 120 activates printing, or otherwise creating a hardcopy output, of each target document linked to a location within a user-selected range of the electronic document. As shown in FIG. 12, the Print window 188 includes a row field 195 into which a range of rows 103 can be input, and a column field 197 into which a range of columns 105 can be input. The input to the row field 195 and the column field 197 will define the range in the electronic document having links to one or more target documents that are to be printed.

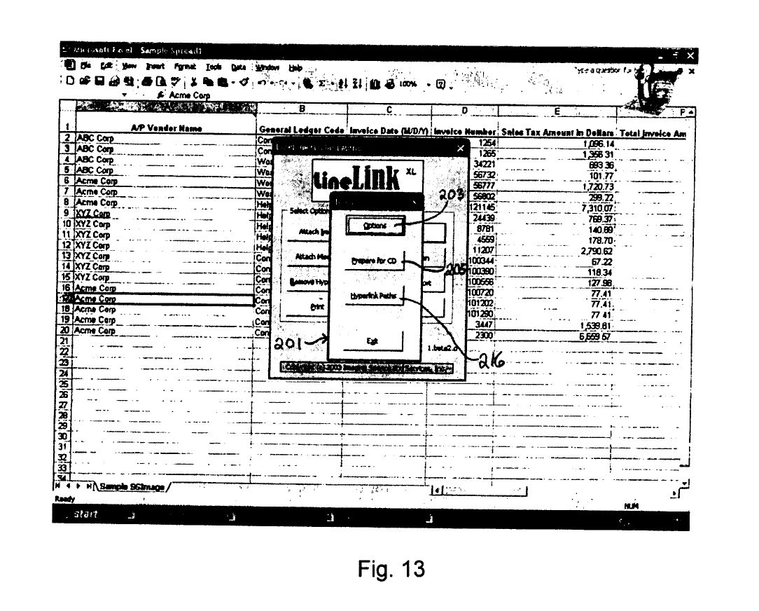

FIG. 13 illustrates a Tools window 201 displayed upon selection of the displaying further options available to the user in creating and maintaining the electronic document, target documents, and the links therebetween. An Options option 203 in the Tools window 201 opens the OPTIONS window 125 discussed above with reference to FIG. 8, allowing the user to edit any information input into the OPTIONS window 125 when it was opened with the initial opening of the DMS 100 within the electronic document.

A Prepare-for-CD option 205 is provided to the Tools window 201 to facilitate transmission of the electronic document to a storage location other than where it was initially created while maintaining the operability of the links. For example, if the electronic document is transmitted to a remote user via email, floppy disk, etc. . . , the remote user will generally not have access to target documents linked to the electronic document that are stored in a computer readable memory of the digital computer 100 of the user who created the electronic document. Thus, by activating a link to a target document that the remote user does not have access to, an error is returned to the remote user instead of the target document. To minimize the errors returned to a remote user, and to enhance portability and reproducibility of the electronic and target documents, the Prepare-for-CD option 205 stores the electronic document in a user-selected, top-level folder, and gathers and stores the linked target documents in a subfolder of the top-level folder.

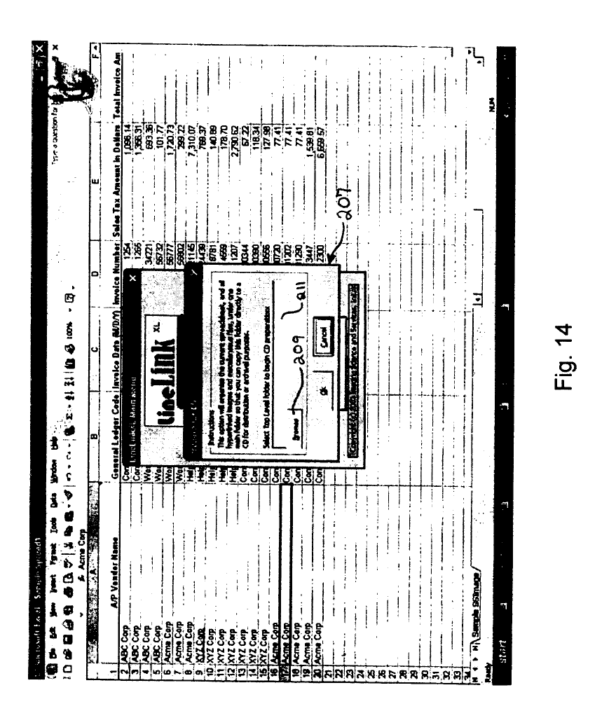

FIG. 14 illustrates a Prepare-for-CD window 207 displayed upon selection of the Prepare-for-CD option 205. A common browse option 209 allows the user to select, or create if necessary, a top-level folder in the computer readable memory that is accessible to the digital computer 10 of the user. The user can also enter the path, or location, of the desired top-level folder directly into path field 211 if the path is known. According to the Prepare-for-CD option 205 of the illustrative embodiment, the electronic document will be stored in the user-selected top-level folder, and the target documents linked to portions of the electronic document will be stored in a subfolder created by the DMS under the top-level folder.

Although the title of the Prepare-for-CD option 205 suggests its use for arranging the electronic and linked documents onto a CD, the Prepare-for-CD option 205 can also be used to store these documents on any computer readable memory. For instance, the Prepare-for-CD option 205 can be used to store the electronic and linked documents in a folder of the user's hard disk so the folder and its contents can be attached to an email to the remote user as mentioned above. Accordingly, the Prepare-for-CD option 205 is not limited for storing the electronic and linked documents onto a CD, but can be used to arrange the electronic and linked target documents to be transmitted to and stored at any location. The Prepare-for-CD option 205 can also be used when the DMS 100 operating on a portable computer 10 is used to scan tangible documents at a remote location, saving the target documents to the computer's hard drive. With the Prepare-for-CD option 205, the saved files can be stored to a network drive (not shown) when the portable computer 10 is returned to an office location and connected to the network. From the network drive, the target documents can be shared with other network members.

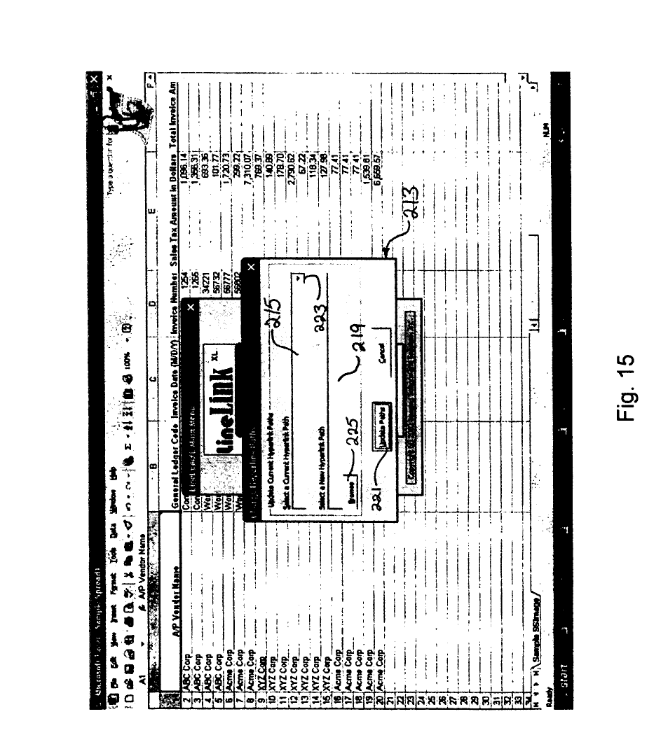

FIG. 15 illustrates a Change-Hyperlink-Paths window 213 generated in response to selection of a Hyperlinks-Path option 216 in the Tools window 201 of FIG. 13. According to the Hyperlinks-Path option 216, the path of target documents linked to locations within a user-selected range of the electronic document will be updated to reflect a new storage location of the target documents in the user-selected range. The user is prompted in the Change-Hyperlink-Paths window 213 to specify a path of a link within the user-selected range to be updated in a current path field 215, and to specify a new path in a new path field 219. All links having the path specified in the current path field 215 will be updated to the new path in the new path field 219 upon the user's selection of the Update-Paths option 221. To select the current path, the user can choose from a pull-down-menu 223 of links within the user selected range, enter the current path directly into the current-path field 215, or select the current path in any other manner. As with the selection of the top-level folder in the Prepare-for-CD option 205 above, the user can select a new path via a common browse option 225, the user can directly enter the new path into the new path field 219, or use any other method made available to the user by the DMS 100 to specify the new path.

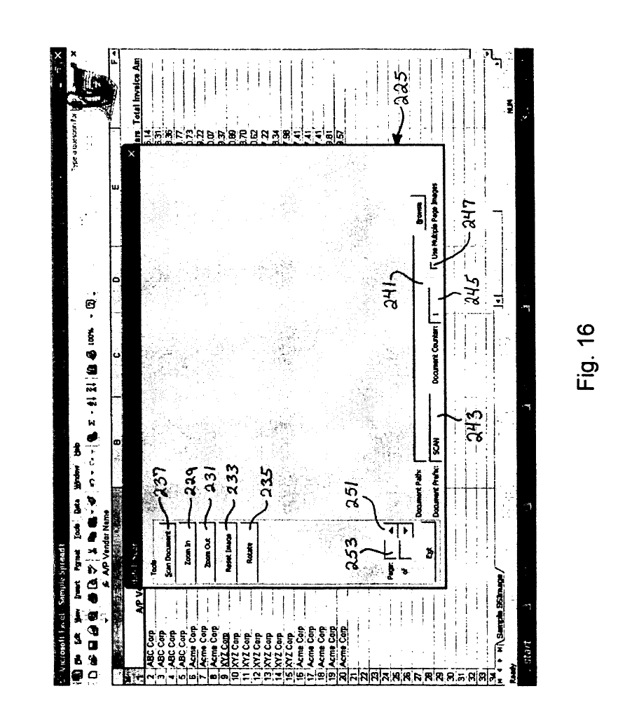

Batch scanning, which was distinguished from scanning a single target document having a plurality of pages above, is a method of continuously and sequentially storing a plurality of target documents in the computer readable memory. With reference to FIGS. 16 and 3C, a Batch-Scan window 225 is to be displayed at step 367 in FIG. 3C in response to selection of a Batch-Scan option 227 (step 365 in FIG. 3A) made available in the main window 120 of FIG. 7. Similar to the Hyperlink-Document window 151 shown in FIG. 9, the Batch-Scan window 225 presents other target document viewing and editing tools that are provided to the illustrative embodiment of the DMS 100, including a Zoom-In option 229, Zoom-Out option 231, Reset-Image option 233, and Rotate option 235. These options are well-known in the art, and don't require a lengthy description herein. Further, their operation is analogous to the operation of those tools discussed above for the Hyperlink-Document window 151.

The phrase “Batch scanning”, as used herein to describe the illustrative embodiment, refers to a continuous scanning operation that allows the user to continuously feed tangible documents to the scanner in a sequential manner. Selecting the Scan-Document option 237 notifies the DMS 100 that batch scanning is to be performed. Prior to selecting the Scan-Document option 237, however, the user is prompted to enter: a path to where the captured target documents are to be stored in the path field 241; a prefix into the Document-Prefix field 243; and a numerical value into a Document-Counter field 245. Just as before, each target document captured by the scanner at step 369 (FIG. 3C) is assigned a file name (step 379) comprising the prefix and the current counter value, and stored sequentially in the computer readable memory at step 385). After each tangible document is scanned, the numerical value in the Document-Counter field 245 is incremented by one at step 381. A subsequently scanned tangible document will be assigned a file name comprising the prefix and the incremented numerical value in the Document-Counter field 245 at step 379.

Batch scanning can be used to continuously perform scanning operations to create a single target document having a plurality of pages, and, a plurality of target documents having a single page, as just described. The difference between scanning according to the Batch-Scan option 227 and scanning according to the Attach-Image option 123 is that the Batch-Scan option 227 performs a generally continuous scanning operation without requiring the user to select a Scan-Document option 237 to capture subsequent target documents. An automatic document feeding device (not shown), such as a bin that holds a plurality of documents to be fed to the scanner, can be coupled to the scanner to allow the continuous scanning operation to proceed without intervention by the operator. In contrast, the Attach-Image option 123 can be used to capture a target document, and then, if further target documents are to be captured, the user is required to reinitiate the Scan-Document option 153 (FIG. 10), and provide information to the window 155 (FIG. 10) to setup the scanner 26 again. The Batch-Scan option 227 can be helpful when a large number of tangible documents are to be scanned to be linked sequentially within a range of locations in the electronic document, or when creating a target document having several pages.

Checking a box 247 in the Batch-Scan window 225 sets an append flag to true at step 375, thereby indicating to the DMS 100 that the user intends to scan a plurality of tangible documents that are to create a single target document having a plurality of pages. When the box 247 is checked, a plurality of tangible documents that are continuously fed to the scanner will be stored in the computer readable memory at step 385 as a single target document with a file name comprising the prefix in the Document-Prefix field 243 and the current value in the Document-Counter field 245. Scanning will automatically continue page-by-page until there are no further tangible documents being fed to the scanner, as determined at step 387. The append flag is an indicator used by the computer 10 operating under instructions from the computer readable logic of the DMS 100 for appending target documents created from subsequently scanned tangible documents to the initial target document at step 377 created for a particular batch scan. As each tangible document is scanned, the electronic version of the tangible document (i.e., the target document) is stored as an electronic file having a file name assigned as described below in a temporary storage location in a computer readable memory. Completion of the batch scanning will occur when no further tangible documents are fed to the scanner and, with the box 247 checked, will result in a single target document comprising a plurality of pages. When this target document is later retrieved by activating an appropriate link, subsequent pages can be viewed by selecting a next-page option (not shown) of the image viewer used to review the target documents.

When the box 247 is not checked, a plurality of tangible documents that are continuously fed to the scanner will be stored in the computer readable memory at step 385 as a plurality of target documents, each with a file name assigned at step 379, the file name comprising a prefix as specified in the Document-Prefix field 243, and a numerical value as specified in the Document-Counter field 245. However, each target document will have a file name differing from an immediately-preceding target document by an incremental value of the number in the Document-Counter field 245. For example, if four documents are generally continuously scanned according to the information input to the fields 243, 245 in FIG. 16, the file names assigned by the DMS 100 to each of these four target documents will be SCAN0001, SCAN0002, SCAN0003 and SCAN0004. These target documents will each be a single target document, and will comprise a single page.

A preview of the one or more target documents captured during the batch-scanning procedure can be generated in the Batch-Scan window 225 before each target document is stored in the computer readable memory. Target documents having a plurality of pages can be previewed by selecting a Page option 251, or by specifying a number of the page to be previewed in a Page field 253.

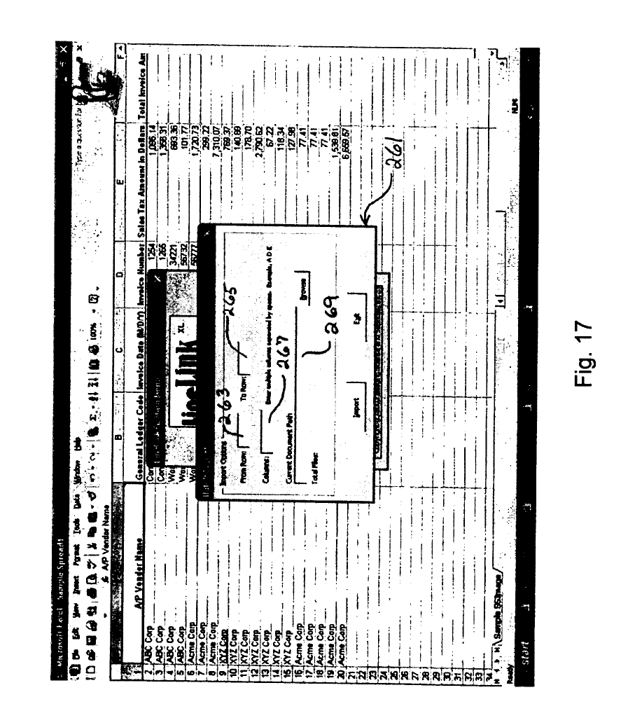

A link for linking each of the target documents created during batch scanning, or otherwise stored sequentially into the computer readable memory, can be substantially simultaneously imported as a batch of links into the electronic document with a Batch-Import option 257 available in the main window 120. Upon selection of the Batch-Import option 257 at step 391, a Batch-Import window 261 is displayed as shown in FIG. 17, prompting the user to input information defining a range of locations within the electronic document at step 393 where the links will be imported to, and the path to the storage location of the target documents to be linked at step 395. According to the illustrative embodiment where the electronic document is a spreadsheet, the user is to input a first row and a final row into a From-Row field 263 and a To-Row field 265, respectively, and one or more columns 105 into a Columns field 267. This information will define a number N of contiguous cells 102 within the spreadsheet that the links will be provided to.

A path to the storage location of the target documents to be batch imported must also be specified in a Current-Document-Path field 269. With this path specified, the user can select the Import option 271, which instructs the DMS 100 to first evaluate the number X of files stored in the storage location within the computer readable memory identified by the path. If the number N of cells 102 does not equal the number X of target documents at the storage location identified by the path input into the Current-Document-Path field 269 as determined at step 397, the user is prompted to correct the number N of cells 102 to correspond to this number X of target documents at step 399. For the user's convenience, the DMS 100 display a total number X of target documents detected at the storage location defined by the path. If the number N of cells 102 does correspond to the number X of target documents in the storage location identified by the path, then a link for each of the target documents is generated at each respective cell 102 defined by the user in the Batch-Import window 261 at step 401.

From the above description of the invention, those skilled in the art will perceive improvements, changes and modifications. Such improvements, changes and modifications within the skill of the art are within the concepts and principles of the invention, as defined by the claims and equivalents.

1. A data-management system to be provided to a digital computer terminal for generating a link in real time between an electronic document opened in a computer application and a target document, said digital computer terminal comprising a computer readable memory and a data-capture device, said data-management system comprising:
data-capture logic for controlling capture of electronic data by said data-capture device;
target-document logic for generating said target document from said electronic data; and
link-generating logic for substantially simultaneously storing said target document in said computer readable memory and generating said link to said target document in said electronic document in real time.

2. The system according to claim 1 further comprising data-management logic for transmitting said electronic document and said target document to a data storage device, wherein said data-management logic automatically updates a path of said link to maintain functionality of said link following said transmission.

3. The system according to claim 2, wherein said data-management logic transmits said electronic document to a top-level folder and said target document to a subfolder of said top-level folder.

4. The system according to claim 2, wherein said data storage device is one of a group consisting of a CD, DVD, floppy disk, hard disk, network drive, magnetic storage device, and any combination thereof.

5. The system according to claim 1 further comprising print-management logic for transmitting said target document to an output device to create a hardcopy of said target document.

6. The system according to claim 1, wherein said computer application is at least one of a group consisting of a word processor, spreadsheet, database, presentation application, web browser, financial planning application, mapping application, and publishing application.

7. The system according to claim 1, wherein said data-capture logic further controls a sequential capture of electronic data for a plurality of target documents to be arranged as a plurality of pages and linked to said electronic document with a single link.

8. The system according to claim 1 further comprising batch-control logic for initiating a sequential capture of electronic data for a plurality of target documents, said target documents to be linked to said electronic document with a plurality of links.

9. The system according to claim 8, wherein said batch-control logic assigns an identifier to a first target document and assigns a unique identifier to each subsequently-captured target document in an incremental manner.

10. The system according to claim 8, wherein said batch-control logic links a single target document to a plurality of locations in said electronic document.

11. The system according to claim 8, wherein said batch-control logic links a plurality of target documents to a single location in said electronic document.

12. The system according to claim 1, wherein said link is provided to an existing item displayed in said computer application.

13. The system according to claim 1 further comprising link-removal logic for removing a link from within a predetermined range in said computer application without removing a displayed item to which said link was provided.

14. The system according to claim 1, wherein the target document is at least one of a group consisting of a text document, an image, a sound recording, and a video recording.

15. The system according to claim 1, wherein said document-management system is provided to said computer application as an add-in.

16. The system according to claim 1, wherein said data-management system is included as a portion of said first computer application.

17. The system according to claim 1 further comprising link-editing logic for updating a path of said link.

18. The system according to claim 1, wherein said link-generating logic further generates a visible icon within said electronic document to identify said link.

19. The system according to claim 1, wherein said link is a hyperlink.

20. A computer application for linking a portion of an electronic document to a target document stored as electronic data representing an information object in a computer accessible memory, said computer application comprising:
link-generating logic for generating a link to said target document in said electronic document; and
data-management logic for transmitting said electronic document and said target document to a data storage device, wherein said data-management logic automatically updates a path of said link to render said link operable following said transmission.

21. The computer application according to claim 20, wherein said desired location is one of a group consisting of a CD, DVD, hard disk, magnetic storage device, web server, network drive, and any combination thereof.

22. The computer application according to claim 20 further comprising print-management logic for printing said target document from within said electronic document.

23. The computer application according to claim 20 further comprising batch-control logic for initiating a sequential capture of electronic data for continuously capturing electronic data for a plurality of target documents.

24. The computer application according to claim 23, wherein said batch-control logic links said plurality of target documents as a multi-page target document to said electronic document with a single link.

25. The computer application according to claim 23, wherein said batch-control logic links each of said plurality of target documents as a single-page target document to said electronic document with a corresponding number of links.

26. The computer application according to claim 23, wherein said batch-control logic assigns an initial identifier to a first target document and a unique identifier to each subsequently-captured target document in an incremental manner.

27. A data-management system for generating a plurality of links to target documents in an electronic document, said data-management system comprising:
means for creating and editing said electronic document;
means for generating a plurality of target documents from electronic data captured by a data-capture device;
means for assigning a sequential identifier to each of said plurality of target documents as said target documents are generated;
means for storing said plurality of captured target documents in a computer readable memory; and
means for generating a link at a plurality of user-selected locations in said electronic document to said plurality of captured target documents.

28. The system according to claim 27 further comprising means for printing said plurality of target documents linked to locations within a user-selected range of said electronic document.

29. The system according to claim 27 further comprising means for transmitting said electronic document and said plurality of target documents to a data storage device in a known relationship, wherein said data manager automatically updates a path of said plurality of said links to said transmitted target documents to maintain functionality of said links following said transmission.

30. The system according to claim 27 further comprising means for transmitting said electronic document to a top-level folder and said plurality of target documents to a subfolder of said top-level folder.

31. The system according to claim 27 further comprising means for updating a path of said plurality of hyperlinks in a user-selected range of said electronic document.

32. A system for linking a target document to a portion of an electronic document in real time, said system comprising:
a computer application for generating and editing said electronic document;
link-generating logic operable with said computer application for generating a link to said target document, wherein
said target document is an electronic reproduction of a hardcopy document and is to be generated by scanning said hardcopy document with an optical data-capture device, further wherein
said link is to be generated at approximately the same time as said captured target document is to be saved, and further wherein
said computer application is one of a group consisting of a spreadsheet, word processor, database, presentation application, and any combination thereof.

33. A data-management system for linking a portion of an electronic document to a target document, said data-management system comprising:
a data-capture device for capturing electronic data representing an information object;
means for generating said target document from said electronic data;
a computer readable memory to store said target document; and
means for substantially simultaneously storing said target document in said computer readable memory and generating a link to said target document in said electronic document.

34. The system according to claim 33, wherein said data-capture device is one of a group consisting of an optical scanner, a camera, a video camera, a sound-recording device, and any combination thereof.

35. The system according to claim 33 further comprising means for transmitting said electronic document and said target document to a data storage device, wherein said transmitting means automatically updates a path of said link to render said link operable following said transmission.

36. The system according to claim 35, wherein said transmitting means transmits said electronic document to a top-level folder in said data storage device and said target document to a subfolder of said top-level folder.

37. The system according to claim 35, wherein said data storage device is one of a group consisting of a CD, DVD, a hard disk, web server, network drive, a magnetic storage medium, and any combination thereof.

38. The system according to claim 33 further comprising an output device for producing a hardcopy of said electronic document.

39. The system according to claim 38 further comprising means for transmitting said target document to produce a hardcopy of said target document.

40. An electronic-document management method for creating and managing an electronic document having a link to a target document in a computer application, said method comprising the steps of:
generating said target document from electronic data representing an information object captured by a data-capture device; and
substantially simultaneously storing said target document in a computer readable memory and generating said link at said user-selected location in said electronic document.

41. The method according to claim 40 further comprising the step of displaying said target document in an inspection window before storing said target document.

42. The method according to claim 40 further comprising the step of:
transmitting said electronic document and said target document to a data storage device upon receiving a command from a user; and
updating a path of said link to render said link operable after said transmission.

43. The method according to claim 42, wherein the step of transmitting said electronic document and said target document comprises the steps of:
transmitting said electronic document to a top-level folder; and
transmitting said target document to a subfolder of said top-level folder.

44. The method according to claim 40 further comprising the step of:
printing said target document upon receiving a print-target command from a user.

45. The method according to claim 40 further comprising the step of displaying an icon to indicate a presence of said link at a location within said electronic document.

46. The method according to claim 40 further comprising the step of updating a path of said link upon receiving a command from a user.

47. An electronic-document management method for creating and managing an electronic document having a plurality of links to target documents in a computer application, said method comprising the steps of:
generating a plurality of target documents from electronic data representing one or more information objects captured by a data-capture device;
sequentially assigning each of said plurality of target documents an identifier and storing said target documents in an order according to said identifier in a computer readable memory; and
generating one or more links to the target documents in said electronic document.

48. The method according to claim 47 further comprising the step of:
transmitting said electronic document and said target documents to a data storage device upon receiving a command from a user; and
updating a path of said links to render said links operable after said transmission.

49. The method according to claim 48, wherein the step of transmitting said electronic document and said target document comprises the steps of:
transmitting said electronic document to a top-level folder; and
transmitting said plurality of target documents to a subfolder of said top-level folder.

50. The method according to claim 47 further comprising the step of:
printing said target documents linked to locations within a user-selected range of said electronic document upon receiving a print-target command from a user.

51. The method according to claim 47 further comprising the step of displaying an icon to indicate a presence of said links at a plurality of locations in said electronic document.

52. The method according to claim 47 further comprising the step of updating a path of said links within a user-selected range of said electronic document upon receiving a command from a user.

53. The method according to claim 47, wherein said step of generating said links comprises the steps of:
identifying a number of user-selected locations for links within a user-selected range of said electronic document;
comparing said number of user-selected locations for links to a number of target documents to be linked; and
generating a link for a target document at each of said user-selected locations if said number of user-selected locations for links is the same as a number of target documents.

54. The method according to claim 47, wherein said step of generating said target documents comprises the step of generating a plurality of single-page target documents.

55. The method according to claim 47, wherein the step of generating said target documents comprises the step of generating a plurality of multi-page target documents.

56. A data-management system for generating a hyperlink in real time between a portion of an electronic document opened in a computer application and a target document, said system comprising:
a digital computer terminal comprising a computer readable memory and a data-capture device;
data-capture logic in communication with said digital computer terminal for controlling capture of electronic data by said data-capture device;
target-document logic in communication with said digital computer terminal for generating said target document from said electronic data; and
link-generating logic in communication with said digital computer terminal for substantially simultaneously storing said target document in said computer readable memory and generating said link to said target document in said electronic document in real time.
